(19) United States
(12) Patent Application Publication
(10) Pub. No.: US 2024/0123593 A1
(43) Pub. Date: Apr. 18, 2024

(54) METHOD FOR OPERATING A POWER TOOL AND POWER TOOL

(71) Applicant: Hilti Aktiengesellschaft, Schaan (LI)

(72) Inventors: Christian SATTLER, Biessenhofen (DE); Michael WIERER, Roethis (AT)

(21) Appl. No.: 18/277,404

(22) PCT Filed: Mar. 2, 2022
(86) PCT No.: PCT/EP2022/055239

§ 371 Date: Aug. 16, 2023

(30) Foreign Application Priority Data
Mar. 11, 2021 (EP) 21162050.5

(51) Int. Cl. B25F 5/00

(52) U.S. Cl. CPC B25F 5/001; B28D 1/041

(57) ABSTRACT

A method for operating a power tool is provided. The power tool has a tool, in particular a drill bit, and a motor, while the motor is a brushless electric motor. In the power tool there is implemented a rotational speed graduation of an electronic form, with which a circumferential speed at the tool of the power tool can be kept essentially constant, while a rotational speed spread DELTA_n of greater than 2 is achieved by the design, dimensioning and/or control of the motor. Also provided is a tool device, for example a core drilling device, with which the proposed method can be carried out. An essential advantage of the invention is that the rotational speed spread DELTA_n of greater than 2 is achieved without a mechanical transmission on the power tool. Instead, a rotational speed graduation of an electronic form is used in the present invention.

The present invention relates to a method for operating a power tool. The power tool has a tool, in particular a drill bit, and a motor, the motor being a brushless electric motor.

### BACKGROUND OF THE INVENTION

Tool devices with which various uses and applications can be implemented are known in the prior art. Such power tools may be in particular core drilling devices, with which cylindrical cores can be drilled out of a substrate, such as concrete. These core drilling devices have drill bits as tools, wherein drill bits with different diameters can be used in order to create boreholes of different sizes. It is also known in the prior art that core drilling devices have a mechanical transmission in order that a user of the device can select and set a gear for operating the core drilling device. The user can select the gear in accordance with the requirements of the planned drilling work or the substrate. For example, the desired torque, the diameter of the drill bit to be used or a desired rotational speed of the drill bit may play a role in the considerations on which the gear selection or gear setting is based.

The drill bit may be for example a diamond drill bit studded with diamonds to increase its cutting power. Such diamond drill bits are often used to drill cores in (reinforced) concrete. Depending on the drill bit used, different combinations of rotational motor speed and motor torque are optimal for such concrete core drilling work.

### SUMMARY OF THE INVENTION

A group of drill bits, for example all drill bits of one type with different diameters (“drill bit line”), can be characterized for example by the so-called diameter spread DELTA_d, which can be calculated as the quotient of a maximum diameter d_max and a minimum diameter d_min: DELTA_d=d_max/d_min. In other words, the diameter of the largest drill bit of a drill bit line is divided by the diameter of the smallest drill bit of a drill bit line in order to determine the diameter spread DELTA_d. Typical dimensions for drill bits lie for example in ranges of 12 to 102 mm for the diameter of the drill bit, 8 to 162 mm, 12 to 450 mm or 82 to 600 mm, with the first specified value representing d_min and the second specified value representing d_max. The specified ranges for the diameters of typical drill bits are preferably also referred to in the sense of the invention as the “tool diameter working range” of the drill bit. A diameter spread DELTA_d can be calculated from the specified minimum and maximum diameter specifications. The corresponding values for the diameter spread for the drill bits given as examples are for example 8.5; 20.3; 37.5 and 7.3, respectively.

A power tool can be characterized by the so-called rotational speed spread DELTA_n, which can be calculated as the quotient of a maximum rotational speed n_max and a minimum rotational speed n_min: DELTA_n=n_max/n_min. It has been shown that it is desirable if the diameter spread DELTA_d of the tool and the rotational speed spread DELTA_n of the power tool could be coordinated such that the power tool can be operated with an optimal combination of rotational motor speed and motor torque for the drill bit used. This is already possible to a limited extent today in the area of power tools that have a mechanical transmission. However, such power tools with a mechanical shift transmission are very bulky and unwieldy, and so their handling can be made more difficult.

In the prior art, power tools which have a mechanical transmission with usually 2 or 3 gears are known. With these 2 or 3 gears of the mechanical transmission, the power tools succeed in allowing a rotational speed spread DELTA_n in a range of for example 2 to 5, while the rotational speed possibilities achieved with the transmission and the available gears are preferably referred to in the sense of the present invention as “rotational speed graduations”.

With the rotational speed graduations that can be provided in power tools with a mechanical transmission, it is disadvantageously not possible to operate all the different combinations of drill bit dimensions optimally. It is a known disadvantage of the prior art that the power tool cannot provide optimal combinations of rotational motor speed and motor torque for all drill bits with different drill bit diameters or diameter spreads. Rather, it has so far been the case that operating individual drill bit types non-optimally is accepted in order to keep the power tools compact and not to have to make the electronics too complex. In particular, in the case of power tools known from the prior art it has been found that compromises have to be accepted, in particular in terms of the drilling speed or the service life of the power tools.

An object on which the present invention is based is to provide a power tool and a method for its operation with which the disadvantages and shortcomings of the prior art can be overcome. In particular, it is intended to provide a power tool and an operating method with which improved operating of different tools with regard to rotational motor speed and motor torque can be made possible by the power tool. This is intended to make an increased drilling speed and a longer service life of the power tool possible. In addition, it would be appreciated by those skilled in the art if lightweight, compact and handy power tools could be provided.

According to the invention, a method for operating a power tool is provided. The power tool has a tool, in particular a drill bit, and a motor, in which case the power tool may be in particular a core drilling device. The method is characterized in that the motor of the power tool is a brushless electric motor and implemented in the power tool is a rotational speed graduation of an electronic form, with which a circumferential speed at the tool of the power tool is kept essentially constant, while a rotational speed spread DELTA_n of greater than 2 is achieved by the design, dimensioning and/or control of the motor. It is most particularly preferred in the sense of the invention that the circumferential speed at the cutting and/or grinding body of the tool remains constant. The cutting and/or grinding body of the tool may preferably also be referred to in the sense of the invention as a “segment”.

In a second aspect, the invention relates to a power tool with a motor and a tool, in particular a drill bit. The power tool is designed to carry out the proposed method, while the motor of the power tool is a brushless electric motor. In the context of the present invention, the proposed power tool can advantageously achieve a rotational speed spread DELTA_n of greater than 2, with an essential advantage of the invention being that the proposed power tool does not require a mechanical transmission. Instead, the invention provides the implementation of a rotational speed graduation of an electronic form, with which a circumferential speed at the cutting and/or grinding segment of the tool of the power tool can be kept essentially constant. The circumferential speed at the drill bit preferably lies in a range of 1 to 10 m/s and particularly preferably in a range of 2 to 6 m/s. The rotational speed spread DELTA_n of greater than 2 is achieved in particular by the design, dimensioning and/or control of the motor of the power tool. It is preferred in the sense of the invention that the power tool has control electronics with which the corresponding method steps can be carried out or settings can be made. The control electronics may be for example part of a control device, which likewise may be part of the power tool.

In the sense of the invention, a rotational speed spread DELTA_n of greater than 2 preferably means that a maximum rotational speed n_max of the power tool or its motor is at least twice as great as a minimum rotational speed n_min of the power tool or its motor. Likewise given for the minimum rotational speed n_min and the maximum rotational speed n_max are the values of the associated torques M_max and M_min for forming a working point suitable for the core drilling application. It is most particularly preferred in the sense of the invention that the rotational speed spread DELTA_n of greater than 2 that is aimed for in the context of the present invention is achieved in dependence on the torque and/or the working points on the characteristic curves shown in FIGS. 2 and 3. In particular, a minimum power range or a minimum power working range is considered for this purpose.

It is preferred in the sense of the invention that the power of the motor is essentially parabolic in dependence on the torque M. This is preferably a downwardly open parabola. It starts at the zero point of a power-torque curve, takes on a maximum value at half the value of the maximum torque M_max and intersects the x-axis at this maximum torque M_max. It is preferred in the sense of the invention that the torque M is plotted on the x-axis of such a power-torque coordinate system, while the power P of the motor is plotted on the y-axis. It has been shown that the parabola described can be shifted upward in the power-torque coordinate system by means of the invention. Advantageously, this results in the area on the x-axis that lies inside the parabola becoming larger. As a result, the range of the minimum power or the corresponding working range can be broadened on the x-axis, with this broadening advantageously also leading to the desired increased rotational speed spread of greater than 2, which is shown on the y-axis.

The power tool and the operating method advantageously allow tools with different dimensions or with different tool diameter working ranges to be better operated by the power tool with regard to rotational motor speed and/or motor torque. This preferably means in the sense of the invention that more suitable combinations of rotational motor speed and motor torque can be provided for these tools or drill bits or that the power tool can be operated with these more suitable combinations of speed and torque, which means that a significantly improved performance of the power tool can be achieved for the different tools that can be used. The provision of more suitable combinations of rotational speed and torque is preferably referred to in the sense of the invention as “operating” the power tool or its tools. The term “operating” is preferably understood in the sense of “offering”.

Improved operating of the power tool is achieved in particular by the rotational speed graduation of an electronic form, with which a circumferential speed at the different tools of the power tool can advantageously be kept essentially constant. In addition, tests have shown that the invention can significantly improve the performance of the proposed power tool, in particular with respect to the drilling speed and the service life of the tools. This can advantageously be achieved by a rotational speed spread DELTA_n of greater than 2, which can be made possible in particular by the design, dimensioning and/or control of the motor of the proposed power tool. The motor of the power tool is a brushless electric motor.

Used in the power tool is a rotational speed graduation of an electronic form, which makes it possible for the circumferential speed at the different tools of the power tool to be kept essentially constant. It is preferred in the sense of the invention that the circumferential speed at the tool of the power tool, which is preferably formed as a drill bit, lies in a range of 1 to 10 m/s and preferably in a range of 2 to 6 m/s.

It is preferred in the sense of the invention that, for drill bits with different dimensions, essentially the same circumferential speed can be provided at the drill bit. In addition, it is preferred in the sense of the invention that the rotational speed spread DELTA_n corresponds to the diameter spread DELTA_d and is graduated in steps of the known tool diameters.

It is most particularly preferred in the sense of the invention that the method does not require a mechanical transmission on the power tool. In other words, the power tool has no mechanical shift transmission. As a result, the power tool can be formed as particularly compact, lightweight and handy, and so it is also significantly easier to operate.

It is preferred in the sense of the invention that the motor of the power tool is designed more powerfully for a higher power than it would have to be for the intended applications and tool diameter working ranges. This overdimensioning of the motor of the power tool is more than compensated for by the volume saving obtained by omitting the mechanical transmission, and so particularly compact and handy power tools or drilling devices can still be provided by means of the invention. Consequently, the invention turns away from the prior art, in which motors specifically designed for the desired areas of application are used, but which then often have to work together with a complex, space-consuming mechanical transmission. The invention turns away from this procedure known in the prior art, in that the rotational speed graduation of the power tool is formed or implemented electronically. Thus, the power tool can be optimized optimally for operating a large number of different drill bits, for example by choosing an overdimensioned motor. The power tool may in particular be optimized for more than one tool diameter working range, and thus advantageously cover greater tool diameter working ranges.

It is preferred in the sense of the invention that, by using a brushless motor with electronically implemented rotational speed graduations, the circumferential speed at the drill bit can be set essentially the same, and in particular optimally, over a wide drill bit diameter working range. The power tool preferably has a rotational speed spread of DELTA_n greater than 2, which can be achieved in particular by the design of the motor, its dimensioning and/or its control. The rotational speed spread of DELTA_n greater than 2 can be made possible in particular by the selected motor design in connection with a rotational speed increase beyond the natural maximum rotational speed of the motor. In addition, the efficiency can be shifted or expanded from a range with high rotational speeds and low torques to a range of low rotational speed and high torque by a defined motor design (cf. FIG. 3). This advantageously allows in particular the higher power requirements of larger drill bits or tools to be operated better. Smaller power values are preferably sufficient for the operating or operation of smaller drill bits, while higher powers of the power tool are required for the operating or operation of larger drill bits. In order to achieve a further expansion or extension of the working range of the power tool, field weakening may be used (cf. FIG. 2).

Significant advantages of the invention are increased system performance, in particular with respect to the drilling speed and service life of the tools, and the elimination of a mechanical shift transmission within the power tool. In addition, an optimal power-to-weight ratio can be provided for a similar area of application, as well as a comparatively great, optimally operable tool diameter working range. The rotational speed increase can be achieved in particular by field weakening. Advantageously, the tool diameter working range increased by the invention can be additionally expanded by the field weakening and by the electronic rotational speed graduation. The advantages of the invention result in particular from the combination of higher rotational speed spread, electronic rotational speed graduation and high efficiency at low rotational speed of the motor of the power tool, the advantages of the invention being made possible in particular by the chosen motor design. It has proven to be advantageous to use an overdimensioned motor with an electromagnetic design specific for field weakening operation in order to allow the advantages of the invention, it being possible in particular to increase the rotational speed of the motor of the power tool by field weakening.

Rotational speed n and torque M of the power tool can be plotted against one another in special diagrams, with a respective relationship between the variables being represented by characteristic curves. Such plots are shown in FIGS. 2 and 3. In the context of the present invention, it is preferred that a specific working range of the power tool or its motor can be shifted from a range with high rotational speeds and low torques to a range of low rotational speed and high torque. While the usual curves that represent the relationship between rotational speed and torque of a conventional power tool have an optimal working range, and thus a range in which the highest efficiency can be achieved, at high rotational speeds and low torques, the proposed power tool preferably works optimally at low rotational speeds and high torques. In other words, it is preferred in the sense of the invention that the proposed power tool is operated at low rotational speeds and high torques and has the maximum efficiency in this working range.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows a view of a preferred embodiment of a power tool with a tool

FIG. 2 shows a plot, given by way of example, of the rotational speed n against the torque M

FIG. 3 shows a plot, given by way of example, of the rotational speed n against the torque M, showing various working points and the efficiency of the power tool.

### DETAILED DESCRIPTION

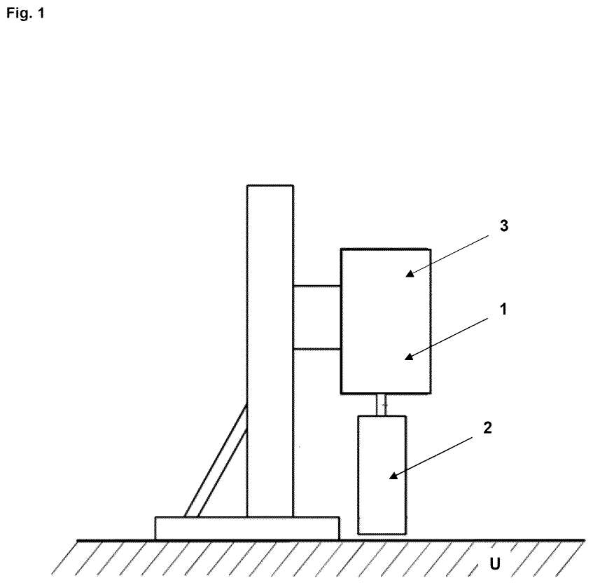

FIG. 1 shows a preferred configuration of the invention. In particular, FIG. 1 shows a power tool 1 with a tool 2. The power tool 1 shown in FIG. 1 is preferably formed as a core drilling device, with the tool 2 being formed by a drill bit. The power tool 1 additionally comprises a motor 3, which is formed as a brushless electric motor. A substrate U, which is shown in the lower area of FIG. 1, can be machined with the power tool 1. Alternatively, vertical walls can also be machined with the power tool 1. Core drilling devices 1 are set up in particular to cut essentially cylindrical cores out of the substrate U using the drill bit 2 as the tool 2. The substrate U is mostly made of concrete, which may also have rebars (“reinforced concrete”). The power tool 1 shown in FIG. 1 is operated together with a drill stand, which holds the power tool 1 during its operation. It may of course also be a hand-held power tool 1.

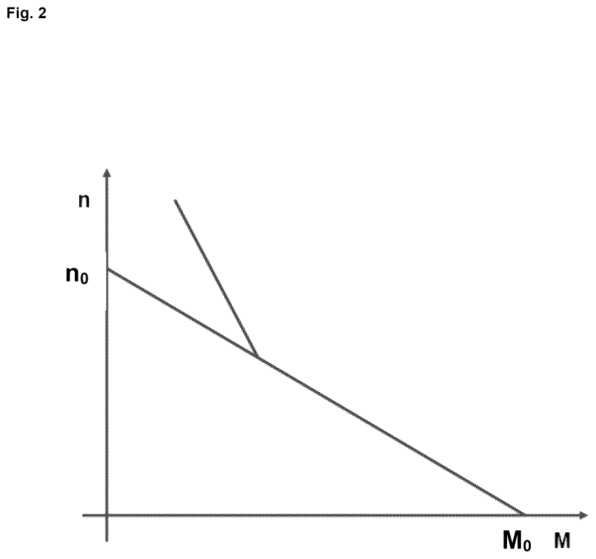

FIG. 2 shows by way of example a plot of the rotational speed n against the torque M. The rotational speed n of the motor 3 of the power tool 1 is in this case plotted on the y-axis, while the torque M is plotted on the x-axis. The curve that describes the relationship between the rotational speed n and the torque M in the power tool preferably represents a straight line with a negative slope, i.e. a falling straight line. The straight line intersects the rotational speed axis at a point n0, while the straight line intersects the torque axis at a point M0. The n(M) curve can be changed by applying field weakening. This changing of the n(M) curve is indicated by the straight line that bends upward and has a steeper gradient. It represents the increase in rotational speed due to field weakening.

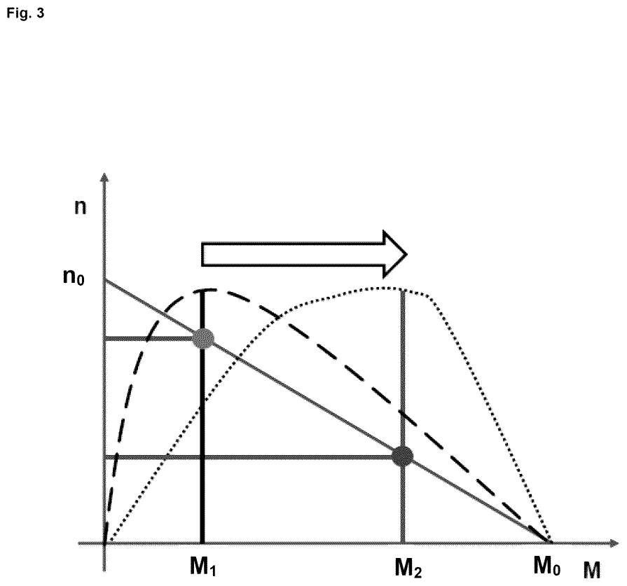

FIG. 3 shows a further plot, given by way of example, of the rotational speed n against the torque M, showing various working points and the efficiency of the power tool 1. The working points are represented in FIG. 3 by circles. The efficiency (widely spaced dashed line) of a conventional power tool, as is known from the prior art, is such that a maximum efficiency is achieved at the torque M1. On the n(M) curve, which extends between the points n0 and M0, there lies for example a first working point, which is characterized by a high rotational speed n and a small torque M. The torque of this first working point preferably corresponds to the maximum efficiency M1 for conventional power tools. The location of this working point and the efficiency curve can be shifted in the context of the present invention such that a second or shifted efficiency curve (narrowly spaced dashed line) is obtained. A second working point, which lies on the n(M) curve between points n0 and M0, is characterized by a low rotational speed n and a high torque M. The maximum M2 of the shifted efficiency curve corresponds to the torque value M2 of this second working point of the power tool 1. The shift in the maximum torques from a value M1 to a value M2 is indicated by the arrow from left to right in the upper area of FIG. 3.

### LIST OF REFERENCE SIGNS

1 Power tool
2 Tool
3 Motor
n Rotational motor speed
M Torque
U Substrate

What is claimed is:

1-9. (canceled)

10. A method for operating a power tool, the power tool having a tool and a motor, the motor being a brushless electric motor, the method comprising:
implementing in the power tool a rotational speed graduation of an electronic form, a circumferential speed at the tool of the power tool remaining constant during the rotational speed graduation, a rotational speed spread DELTA_n of greater than 2 being achieved by design, dimensioning or control of the motor, the rotational speed spread DELTA_n being defined as the quotient of a maximum rotational speed n_max and a minimum rotational speed n_min.

11. The method as recited in claim 10 wherein the circumferential speed at the tool of the power tool lies in a range of 1 to 10 m/s.

12. The method as recited in claim 11 wherein the circumferential speed at the tool of the power tool lies in a range of 2 to 6 m/s.

13. The method as recited in claim 10 wherein the method does not require a mechanical transmission on the power tool.

14. The method as recited in claim 10 wherein the rotational speed spread DELTA_n of the power tool corresponds to a diameter spread DELTA_d of a group of tools, the diameter spread DELTA_d being the quotient of a maximum diameter d_max and a minimum diameter d_min.

15. The method as recited in claim 10 wherein the power tool has a rotational speed range and a torque range and is operated in a lower half of the rotational speed range and an upper half of the torque range.

16. The method as recited in claim 10 wherein the circumferential speed at a cutting or grinding body of the tool of the power tool remains constant.

17. The method as recited in claim 10 wherein the tool is a drill bit.

18. A power tool comprising:
a motor; and
a tool,
the power tool designed to carry out the method as recited in claim 10, the motor of the power tool being a brushless electric motor.

19. The power tool as recited in claim 18 wherein the tool is a drill bit.

20. The power tool as recited in claim 18 wherein the power tool has no mechanical transmission.

21. The power tool as recited in claim 18 wherein the power tool has a rotational speed range and a torque range and is operatable in a lower half of the rotational speed range and an upper half of the torque range.
